(19) United States
(12) Patent Application Publication
(10) Pub. No.: US 2026/0329588 A1
(43) Pub. Date: Oct. 22, 2026

(54) COMPUTING CIRCUIT COMPRISING ENHANCED RISC-V PIPELINED ARCHITECTURE CALCULATION CORE

(71) Applicant: STMICROELECTRONICS INTERNATIONAL N.V., Geneva (CH)

(72) Inventors: Tommaso SPAGNOLO, Milano (IT); Riccardo MASSA, Monza (IT); Thomas BOESCH, Rovio (CH); Giuseppe DESOLI, San Fermo Della Battaglia (IT); Filippo GRILLOTTI, Milano (IT)

(21) Appl. No.: 19/535,661

(22) Filed: Feb. 10, 2026

(30) Foreign Application Priority Data
Feb. 24, 2025 (FR) 2501878

(51) Int. Cl. G06F 9/38; G06F 9/30

(52) U.S. Cl. CPC G06F 9/3867; G06F 9/30036

(57) ABSTRACT

The present disclosure relates to a computing circuit. An example computing circuit comprises: at least one calculation core based on a reduced instruction set computer (RISC-V) pipelined architecture; and one or several memory circuits configured to implement in-memory computing (IMC). The calculation core comprises an execution stage configured to use the one or several memory circuits to implement IMC.

### CROSS REFERENCE TO RELATED APPLICATIONS

This application claims the priority benefit of French Patent Application Number 2501878, filed on Feb. 24, 2025, entitled “CIRCUIT DE CALCUL COMPRENANT UN NOYAU DE CALCUL A ARCHITECTURE PIPELINE RISC-V AMELIOREE”, which is hereby incorporated by reference to the maximum extent allowable by law.

### TECHNICAL FIELD

The present disclosure relates generally the field of reduced instruction set computer, RISC-V, computing circuits and devices. The present disclosure also concerns hardware architectures for artificial intelligence, AI, workload acceleration.

### BACKGROUND

The rapid advancements in AI and machine learning, ML, have introduced unprecedented computational demands, particularly with the rise of deep learning applications across various fields such as healthcare, autonomous systems, and natural language processing. These computational requirements are especially challenging for edge computing devices, which are constrained by limited power and memory resources.

Traditional computing architectures, including CPUs (Central Processing Units) and GPUs (Graphics Processing Units), struggle to efficiently handle these tasks due to the frequent movement of data between memory and processing units, a phenomenon often referred to as the “memory wall”. This bottleneck significantly increases latency and energy consumption, making it difficult to meet the demands of energy-efficient embedded systems. Moreover, the inherent CPU serial computation approach is not well suited for AI workload that need extensive computation parallelization.

Neural Processing Units, NPUs, have been developed to offer calculation circuits adapted to AI and ML applications. However, these circuits might be too costly to be considered for low-end devices due to their high impact on required silicon area and power.

### BRIEF SUMMARY

There is a need to propose a computing circuit adapted to high computational requirements and which does not have at least part of the drawbacks of known solutions.

One embodiment addresses all or some of the drawbacks of known solutions and provides a computing circuit comprising:
at least one calculation core based on a reduced instruction set computer, RISC-V, pipelined architecture;
one or several memory circuits configured to implement in-memory computing, IMC; and wherein the calculation core comprises an execution stage configured to use the one or several memory circuits to implement IMC.

According to a particular embodiment, at least one of the one or several memory circuits is embedded in the calculation core and configured to be used as an IMC functional unit of the execution stage of the calculation core.

According to a particular embodiment, the computing circuit further comprises an interconnect linking the calculation core to at least one tightly-coupled memory, TCM, and to a bus to which an external memory is coupled.

According to a particular embodiment, the at least one TCM corresponds to at least one of the one or several memory circuits.

According to a particular embodiment, the execution stage of the calculation core comprises at least one stream controller and at least one of the one or several memory circuits is connected to the stream controller through input and output stream links.

According to a particular embodiment, the computing circuit further comprises a vector calculation core configured to implement computations on vector data and comprising a RISC-V pipelined architecture.

According to a particular embodiment, at least one of the one or several memory circuits is embedded in the vector calculation core and configured to be used as an IMC functional unit of an execution stage of the vector calculation core.

According to a particular embodiment, the interconnect also links the vector calculation core to the TCM and to the bus to which the external memory is coupled.

According to a particular embodiment, the vector calculation core comprises an instruction set which includes vector memory read instructions to fetch tensor data which forms a three-dimension matrix, from an external memory to at least one vector register file of the vector calculation core, such that the tensor data is flatten following an order Z>Y>X, with X, Y and Z corresponding to the three axis of the matrix.

According to a particular embodiment, the calculation core comprises an instruction set which includes data manipulation instructions configured to, during consecutive first and second convolutions of tensor data with kernel data, shift the tensor data stored in at least one register file of the calculation core and used for the first convolution such that part of the tensor data common to the first and second convolutions are kept in the register file.

According to a particular embodiment, the calculation core is configured to load in parallel, in a single cycle, data stored in several registers of at least one register file of the calculation core in a location of at least one of the one or several memory circuits.

According to a particular embodiment, the calculation core comprises at least one register file configured to store several partial sums resulting of convolutions implemented by the calculation core.

According to a particular embodiment, the one or several memory circuits are digital and/or analog IMC circuits.

According to a particular embodiment, the calculation core comprises at least one register file and at least four stages including an instruction fetch stage, an instruction decode stage, the execution stage, and a write back stage.

Another embodiment provides an apparatus corresponding to a microprocessor or a microcontroller or a system-on-chip, SoC, and comprising at least one computing circuit.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically shows an example of a computing circuit according to a first embodiment;

FIG. 2 schematically shows an example of a computing circuit according to a variant of the first embodiment;

FIG. 3 schematically shows an example of a computing circuit according to a second embodiment;

FIG. 4 schematically shows an example of a computing circuit according to a variant of the second embodiment;

FIG. 5 schematically shows an example of a computing circuit according to a third embodiment;

FIG. 6 schematically shows an example of a computing circuit according to a fourth embodiment;

FIG. 7 schematically shows an example of an operation implemented on vector data by a computing circuit according to a particular embodiment;

FIG. 8 schematically shows an example of an organization of data in a vector register file, implemented by a computing circuit according to a particular embodiment;

FIG. 9 schematically shows an example of data reorganization in a vector register file implemented by a computing circuit according to a particular embodiment;

FIG. 10 and FIG. 11 schematically show steps implemented during a data reorganization in a register file of a computing circuit according to a particular embodiment;

FIG. 12 schematically shows an example of fetching data stored in multiple registers in the IMC memory circuit(s) of a computing circuit according to a particular embodiment;

FIG. 13 schematically shows an example of write back strategy implemented by a computing circuit according to a particular embodiment;

FIG. 14 schematically shows an example of operations implemented on tensor data with partial kernel data by the computing circuit 100 according to a particular embodiment;

FIG. 15, FIG. 16, FIG. 17 and FIG. 18 schematically show example of instructions implemented by a computing circuit according to a particular embodiment;

FIG. 19 schematically shows dimensions of vector data used for calculation of performances of a computing circuit according to a particular embodiment;

FIG. 20 and FIG. 21 show performances calculated for a computing circuit according to a particular embodiment;

FIG. 22 schematically shows an apparatus including a computing circuit according to a particular embodiment.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, various elements (calculation cores, memory, interconnect, etc.) of the computing circuit are not described in detail. A person skilled in the art will be able to implement, in a detailed manner, these elements based on the functional description provided herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures during normal use.

Unless specified otherwise, the expressions “around”, “approximately”, “substantially” and “in the order of” signify within 10 %, and preferably within 5 %.

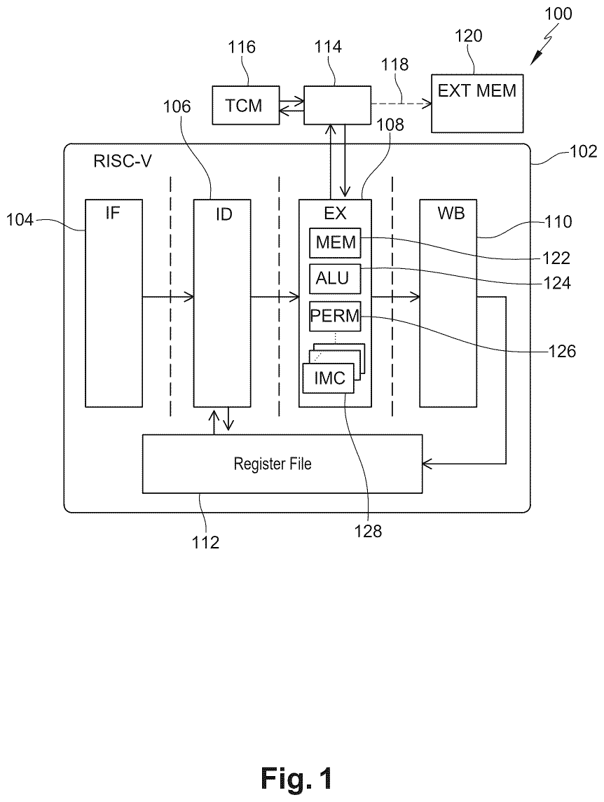

An example of a computing circuit 100 according to a first embodiment is described below in relation with FIG. 1.

The computing circuit 100 comprises at least one calculation core 102 based on a RISC-V pipelined architecture. The computing circuit 100 is thus configured to support execution of a program that is based on an instruction set architecture, ISA, of the RISC-V type.

In the example shown in FIG. 1, the calculation core 102 of the computing circuit 100 comprises circuitry arranged according to pipelined four stages which are:
an instruction fetch (IF) stage 104 configured to fetch instructions from a memory (not shown in FIG. 1) and to send the instructions to an instructions decode (ID) stage 106;
the ID stage 106 configured to decode instructions fetched by the IF stage 104, to retrieve data from at least one register file 112 of the calculation core 102 and to send the retrieved data to an execution (EX) stage 108;
the EX stage 108 configured to execute the operation(s) required by the instruction (memory access, arithmetic operations, data permutation, etc.), and to send result data to a Write Back (WB) stage 110;
the WB stage 110 configured to write back result data to the register file(s) 112.

As a variant, the pipelined architecture of the calculation core 102 may comprise a different number of stages compared to the example shown in FIG. 1. In addition, it is also possible that the calculation core 102 comprises one or several register files.

In the example shown in FIG. 1, the computing circuit 100 further comprises an interconnect 114, e.g. a crossbar-type interconnect or another type of interconnect, coupling the calculation core 102 to at least one tightly-coupled memory, TCM, 116 and to a bus 118 to which an external memory 120 is coupled. In this configuration, the calculation core 102, and more particularly the EX stage 108, can fetch data from the external memory 120 and send data to the external memory 120 through the interconnect 114. The memory 120 is named “external memory” because it is external to the calculation core 102. For example, the external memory 120 corresponds to an L1/L2 cache, a SRAM (Static Random-Access Memory), a DRAM (Dynamic Random-Access Memory), etc.

Compared to the external memory 120, the TCM 116 is directly attached to a dedicated port of the pipelined circuit, i.e. the calculation core 102, as opposed to the memory 120 which is accessed via standard load/store units and cache or other levels of hierarchy.

A cache is a memory storage controlled transparently by logic that stores temporary data accessed by the processor to be possibly reused multiple times for temporal locality or spatial locality. Compared to a cache memory, the TCM 116 behaves like a normal memory. Compared to the external memory 120, the TCM 116 is faster to access and had a lower latency from the calculation core 102 point of view.

In the example shown in FIG. 1, because of its tightly-coupled nature, and compared to a standard memory, the TCM 116 enables to speed up memory access of the calculation core 102 on frequently accessed data which are stored in the TCM 116. As a variant, the computing circuit 100 may not comprise the TCM 116.

In a particular embodiment, one or several of the stages 104 to 110 of the calculation core 102 comprise multiple sub-stages. For example, in the computing circuit 100 shown in FIG. 1, the EX stage 108 comprises multiple sub-stages each forming functional units of the stage. In the example shown in FIG. 1, the EX stage 108 comprises a memorization, MEM, sub-stage 122 configured to generate memory access requests (read/write) to the external memory 120, an arithmetic logic unit, ALU, sub-stage 124 configured to perform required operations on data (addition, multiplication, etc.), and a permutation, PERM, sub-stage 126 to perform permutations on data.

The computing circuit 100 also comprises one or several memory circuits 128 configured to implement in-memory computing, IMC, or compute in-memory, CIM. The EX stage 108 is configured to use the one or several memory circuits 128 to implement IMC. More particularly, in the first embodiment here described, at least one of the memory circuit(s) 128 is embedded in the calculation core 102 and configured to be used as an IMC functional unit of the EX stage 108 of the calculation core 102. In the example shown in FIG. 1, several memory circuits 128 are embedded in the EX stage 108 as multiple IMC tiles. The memory circuit 128 may be digital (thus forming digital in-memory computing, DIMC), or analog (thus forming analog in-memory computing, AIMC).

In this first embodiment, IMC memory circuits 128 are embedded inside the RISC-V execution pipeline of the calculation core 102 as a functional unit. By adopting this integration approach, IMC is directly embedded within the calculation core 102, enabling seamless operations as part of the execution flow of the calculation core 102.

In the particular architecture of the computing circuit 100, custom RISC-V instructions can be introduced to manage data transfer, computation, and result storage. For example, these instructions include operations for loading input features and kernels data from the external memory 120 to the IMC memory circuit(s) 128, triggering multiply and accumulate, MAC, computations, and WB after processing.

In the example shown in FIG. 1, the IMC unit added in the calculation core 102 comprises multiple IMC blocks, named IMC tiles, corresponding to multiple IMC memory circuits 128. Each IMC tile can be programmed in parallel for independent execution. As a variant, the EX stage 108 of the calculation core 102 may comprise a single IMC memory circuit 128 forming a single IMC block, or a single IMC tile.

As a variant, the EX stage 108 of the calculation core 102 may comprise a different number of sub-stages compared to the example shown in FIG. 1.

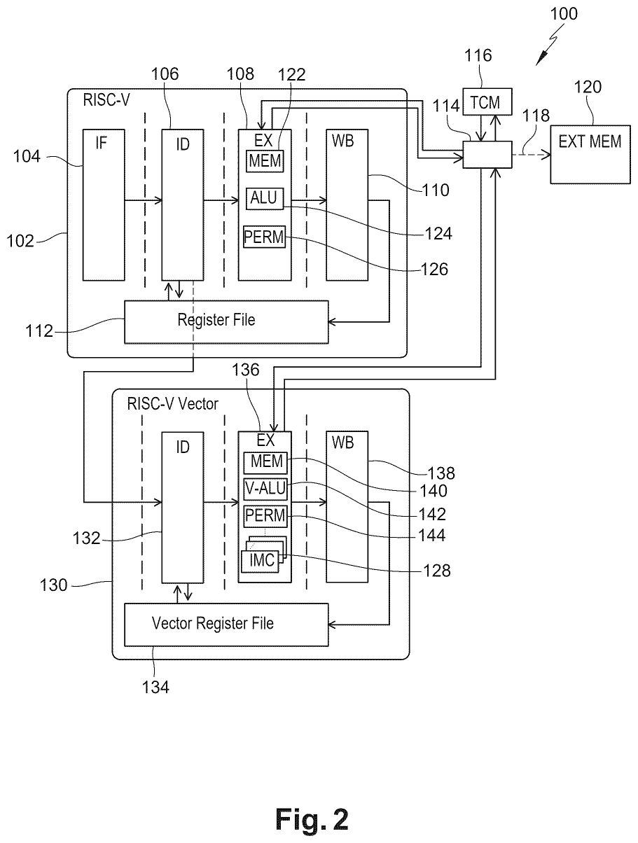

An example of a computing circuit 100 according to a variant of the first embodiment is described below in relation with FIG. 2.

Compared to the computing circuit 100 previously described in relation with FIG. 1, the computing circuit 100 according to this variant further comprises a vector calculation core 130 configured to implement computations on vector data and comprising, as the calculation core 102, a RISC-V pipelined architecture. In this configuration, the RISC-V instruction set is further extended with vector instructions to efficiently handle computations on vector data, these vector instructions being executed by the vector calculation core 130. This vector extension can be designed to exploit data-level parallelism for high-performance workloads. In the computing circuit 100 according to this variant, the calculation core 102 is configured to implement scalar data calculations, and the vector calculation core 130 is configured to implement vector data calculations.

In the configuration shown in FIG. 2, the vector calculation core 130 receives, in an ID stage 132, the vector instructions from the ID stage 106 of the calculation core 102. The vector instructions are initially pre-decoded in the ID stage 106 of the calculation core 102. The full decoding process of the vector instructions is then completed within the ID stage 132 of the vector calculation core 130. The vector calculation core 130 also comprises at least one vector register file 134 coupled to the ID stage 132. In this example, the ID stage 132 is configured to decode instructions sent by the ID stage 106 of the calculation core 102, to retrieve data from the vector register file 134 and to send the retrieved data to an EX stage 136 of the vector calculation core 130. The EX stage 136 is here configured to execute the vector instructions required by the received instructions on vector data that are stored/loaded from/to the vector register file 134. The vector calculation core 130 also comprises a WB stage 138 configured to write back result data outputted by the EX stage 136 to the vector register file 134. In this example, the vector calculation core 130 is thus configured to receive vector instructions from the calculation core 102 and to execute the vector instructions on vector data stored in the vector register file 134.

In a particular embodiment, one or several of the stages 132, 136, 138 of the vector calculation core 130 comprise multiple sub-stages. For example, in the computing circuit 100 shown in FIG. 2, the EX stage 136 comprises multiple sub-stages each forming functional units of the stage. In the example shown in FIG. 2, the EX stage 136 comprises a MEM sub-stage 140 configured to generate memory access requests (read/write) to the external memory 120, a vector arithmetic logic unit, V-ALU, sub-stage 142 configured to perform required operations on vector data (addition, multiplication, etc.), and a PERM sub-stage 144 to perform permutations on vector data.

In the example shown in FIG. 2, the interconnect 114 couples the EX stage 108 of the calculation core 102 and the EX stage 136 of the vector calculation core 130 to the TCM 116 and to the bus 118 to which the external memory 120 is coupled. Thus, in this variant, the vector calculation core 130 corresponds to a vector coprocessor which can independently handle memory accesses to the TCM 116 and to the external memory 120.

In this variant, to better exploit vector data operations and vector instructions, the IMC memory circuit(s) 128 is/are directly integrated, or embedded, inside the vector calculation core 130, i.e. inside the RISC-V vector co-processor pipeline of the computing circuit 100. In this variant, the IMC memory circuit(s) 128 is/are configured to be used as IMC functional units of the EX stage 136 of the vector calculation core 130. Thus, the IMC memory circuit(s) 128 can benefit from a larger vector register file 134 (for example 32×64 bit) that is specifically adapted for long vector data, better matching the vector data operations executed inside the IMC memory circuits 128 for example during a ML workload. To fully support this implementation, the RISC-V vector ISA can be extended with custom instructions to specifically handle IMC-related operations (load, store, execution, start, etc.).

The different features and variants previously described for the computing circuit 100 shown in FIG. 1 can apply to the computing circuit 100 shown in FIG. 2.

In the example shown in FIG. 2, the IMC memory circuit(s) 128 is/are embedded in the vector calculation core 130 only. According to a variant not shown in the Figures, the computing circuit 100 can comprise the calculation core 102 and the vector calculation core 130, and IMC memory circuit(s) 128 can be embedded in the calculation core 102, for example as shown in FIG. 1, and in the vector calculation core 130, for example as shown in FIG. 2. Such configuration enables to maximize the workload parallelization.

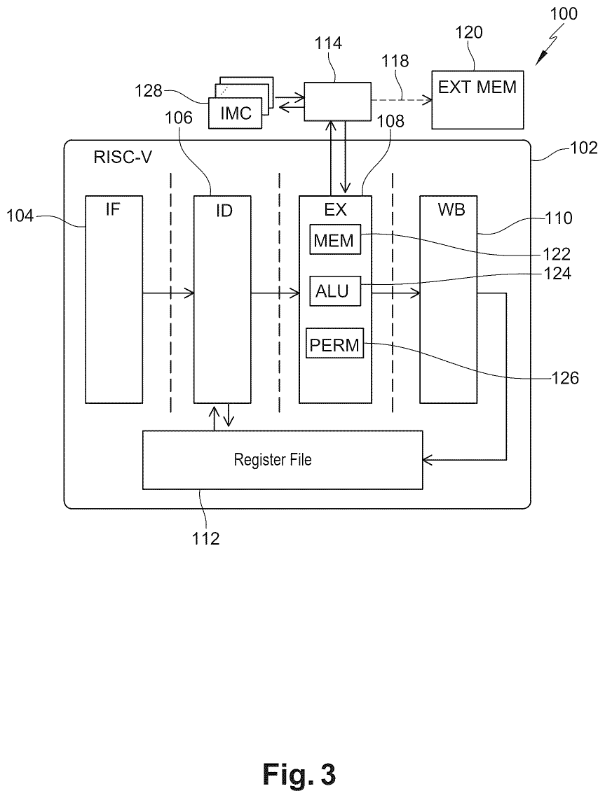

An example of a computing circuit 100 according to a second embodiment is described below in relation with FIG. 3.

In the example shown in FIG. 3, the computing circuit 100 comprises the same elements as those of the computing circuit 100 previously described in relation with FIG. 1, i.e. the calculation core 102 including the stages 104, 106, 108 and 110, the register file(s) 112, the interconnect 114, the bus 118 and the external memory 120. In the configuration shown in FIG. 3, the EX stage 108 of the calculation core 102 does not comprise IMC memory circuit(s) 128 embedded as functional unit. Indeed, compared to the first embodiment in which at least one IMC memory circuit 128 is embedded in the calculation core 102 and/or in the vector calculation core 130 as functional unit, the computing circuit 100 comprises at least one IMC memory circuit 128 (several IMC memory circuits 128 in the example shown in FIG. 3) integrated as a TCM through the interconnect 114. Thus, in this configuration, an IMC unit is directly connected to the RISC-V computation circuit as a TCM. This implementation enables to reduce the design integration complexity as it does not require changes to the execution pipeline of a RISC-V calculation core.

In this second embodiment, the IMC unit, formed by the one or several IMC memory circuits 128, can be directly accessible by the calculation core 102 through a high-bandwidth memory interface formed by the interconnect 114. Moreover, in this configuration, the buffers of the IMC unit may act as fast local memory for storing intermediate data, such as input data features, kernel weights, or partial sums, allowing for reduced memory latency and improved execution efficiency. Finally, this approach enables reuse of existing RISC-V memory instructions (because the architecture of the calculation core 102 is not modified by addition of IMC functional unit as in the first embodiment), simplifying control logic and facilitating efficient data reuse.

Compared to the first embodiment in which the integration of IMC as functional unit can focus on leveraging specialized compute instructions for direct acceleration, the integration of IMC unit as a TCM minimizes memory access bottlenecks by acting as an intermediary storage for high-demand data during execution. This approach can offer a significant advantage in its broader compatibility with different calculation cores, as it requires fewer customizations to the existing architectures. By integrating the IMC as a high-bandwidth memory resource, the TCM integration can be seamlessly supported with existing RISC-V memory instructions without extensive modifications to the instruction set or execution pipeline. This flexibility makes the TCM integration particularly appealing for applications requiring portability across multiple core designs or processor configurations. In addition, the integration of IMC memory circuit as a TCM enables to get a substantial amount of calculation acceleration capability for a small cost. Finally, this configuration can facilitate integration into heterogeneous systems and cores without the need for extensive redesign, enabling easier adoption of IMC technology in diverse hardware platforms.

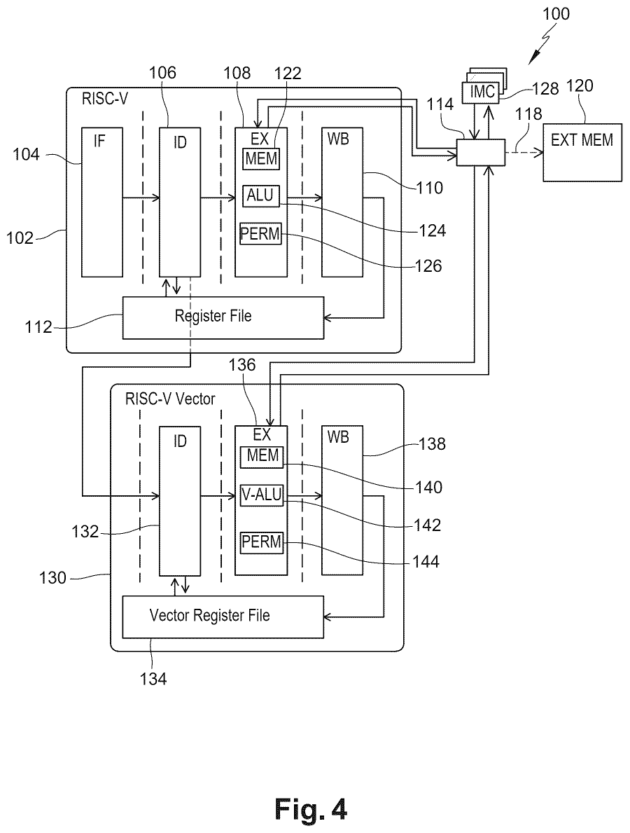

An example of a computing circuit 100 according to a variant of the second embodiment is described below in relation with FIG. 4.

Compared to the computing circuit 100 previously described in relation with FIG. 3, the computing circuit 100 according to this variant further comprises the vector calculation core 130 similar to that of the computing circuit 100 previously described in relation with FIG. 2, except that the EX stage 136 of the vector calculation core 130 does not comprise the IMC memory circuit(s) 128 embedded as functional unit. As in the example shown in FIG. 2, the interconnect 114 also couples the EX stage 136 of the vector calculation core 130 to the IMC memory circuits 128 integrated as a TCM and to the bus 118 to which the external memory 120 is coupled. The IMC memory circuits 128 are thus accessible to the calculation core 102 and to the vector calculation core 130 to enhance computations implemented on vector data. In this solution, both the scalar calculation core and the vector calculation core can benefit from the IMC integration as a TCM.

The different features and variant previously described for the computing circuit 100 shown in FIG. 3 may apply to the computing circuit 100 shown in FIG. 4.

The different features and variants previously described for the first embodiment may apply for the second embodiment.

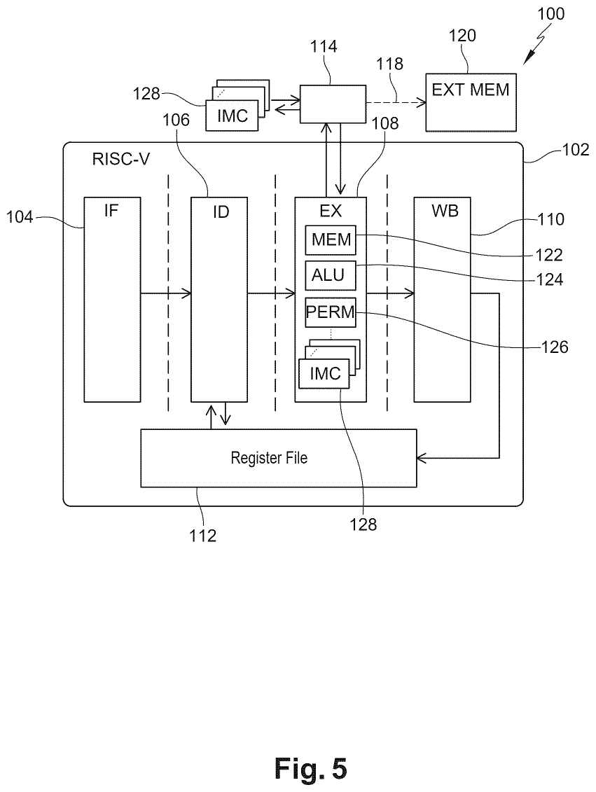

The IMC integration proposed in the first and second embodiments can be mixed, as shown in the computing circuit 100 according to a third embodiment described in relation with FIG. 5.

In the example shown in FIG. 5, the computing circuit 100 comprises the same elements as those of the computing circuit 100 previously described in relation with FIGS. 1 and 3, i.e. the calculation core 102 including the stages 104, 106, 108, 110, the register file 112, the interconnect 114, the bus 118 and the external memory 120. However, compared to the first and second embodiments in which at least one IMC memory circuit 128 is embedded in the calculation core 102 and/or in the vector calculation core 130, or as a TCM, at least one IMC memory circuit 128 is embedded in the calculation core 102, and at least one another IMC memory circuit 128 is embedded as a TCM and interconnected to the calculation core 102 through the interconnect 114, thus providing a high level of flexibility.

In this third embodiment, the combination of both approaches of the first and second embodiments (IMC memory circuits 128 embedded as functional unit in calculation core and as TCM) offer complementary benefits: the integration of IMC as functional unit prioritizes direct computational acceleration, while the integration of IMC in TCM enhances system scalability and adaptability. Together, they provide a good solution for improving performance and energy efficiency, for example in edge-based neural network inference.

According to a variant of this third embodiment, the computing circuit 100 can comprise the vector calculation core 130 as previously described for the first and second embodiments. In this case, IMC memory circuits 128 can be embedded:
as functional unit in the calculation core 102, and as a TCM, or
as functional unit in the vector calculation core 130, and as a TCM, or
as functional units in the calculation core 102 and in the vector calculation core 130, and as a TCM.

The different features and variants previously described for the first and second embodiments may apply for the third embodiment.

In the previous embodiments in which the IMC memory circuits 128 are integrated as a TCM, the circuits 128 carry out both memory and computing functions. The operation of the IMC memory circuits 128 as computing devices from the calculation core 102 and/or the vector calculation core 130 can be done thanks to an extension of the instruction set of the calculation core 102 and/or the vector calculation core 130.

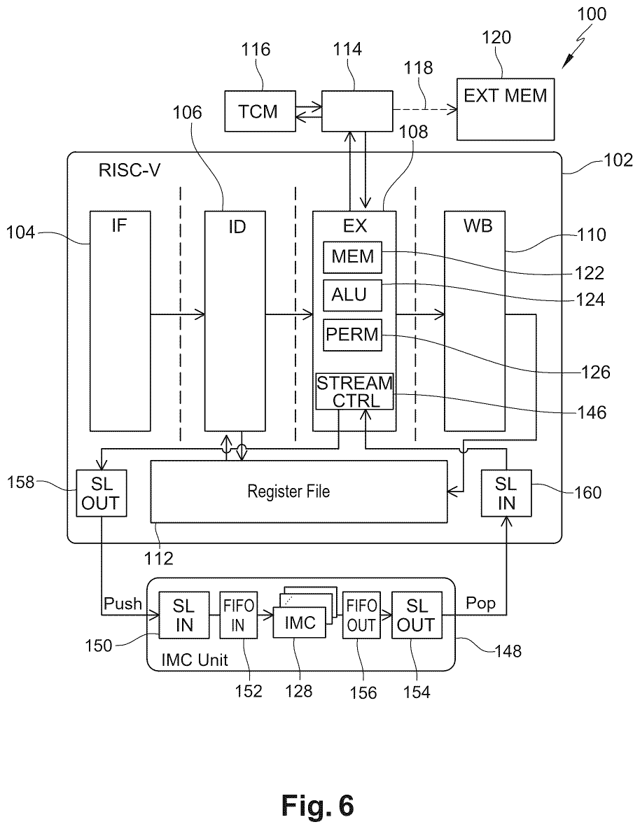

An example of a computing circuit 100 according to a fourth embodiment is described below in relation with FIG. 6.

In the example shown in FIG. 6, the computing circuit 100 comprises the same elements as those of the computing circuit 100 previously described in relation with FIG. 1, i.e. the calculation core 102 including the stages 104, 106, 108, 110, the register file 112, the interconnect 114, the TCM 116, the bus 118 and the external memory 120. However, in this fourth embodiment, the EX stage 108 of the calculation core 102 does not embed at least one IMC memory circuit 128. In this fourth embodiment, the EX stage 108 comprises at least one stream controller 146, and at least one IMC memory circuit 128 is connected to the stream controller 146 through input and output stream links. In the configuration shown in FIG. 6, at least one IMC memory circuit 128 belongs to an IMC unit 148 also comprising a first stream link input interface 150, a first FIFO (First In First Out) memory 152 coupled between the first stream link input interface 150 and the IMC memory circuit(s) 128, a first stream link output interface 154, and a second FIFO memory 156 coupled between the first stream link output interface 154 and the IMC memory circuit(s) 128. The stream controller 146 is coupled to the first stream link input interface 150 through a second stream link output interface 158 of the calculation core 102, and to the first stream link output interface 154 through a second stream link input interface 160.

This fourth embodiment proposes another integration strategy wherein the IMC operates as an external unit to the calculation core(s), connected to the RISC-V calculation core through a stream-based interface. In this configuration, the calculation core 102 contains a new functional unit in the EX stage 108, formed by the stream controller 146 configured to send and receive data packets to the external IMC unit 148. In this embodiment, the IMC unit 148 receives data through the input stream link. Data are collected in the first FIFO memory 152. The at least one IMC memory circuit 128 is fed with data and control signals coming from the first FIFO memory 152. Once the IMC computation is completed, data are stored into the second FIFO memory 156 before being sent to the EX stage 108 of the calculation core 102 through the output stream link.

An advantage of this integration proposed in this fourth embodiment is that the RISC-V calculation core 102 and the IMC unit 148 executions are detached one to the other. The RISC-V pipelined architecture is not bottlenecked by the IMC execution which can be carried out in parallel because new data are pushed into the first FIFO memory 152. The IMC computation is thus handled as a queue of operations. RISC-V calculation core may be programmed through custom instruction for data pushing into the IMC memory circuit(s) 128. Similarly, custom instructions may be used to pop data from the IMC unit 148 when data are ready. This implementation fully decouples the RISC-V pipelined execution from the IMC execution, allowing for a more flexible workload execution.

For example, this solution is easier than a more conventional, address-based loosely coupled integration of IMC which requires an external bus for sending Data/Control signals, and thus generally requires more area, power, and possibly additional delays due to bus arbitration.

For example, as a variant of this fourth embodiment, the computing circuit 100 may comprise the vector calculation core 130. In this case, it is possible to couple one or several IMC units 148, through stream links, to one or several stream controller 146 which belong to the EX stage 108 of the calculation core 102 and/or to the EX stage 136 of the vector calculation core 130. It is also possible to integrate IMC memory circuit(s) as functional units in the calculation core 102 and/or in the vector calculation core 130 and/or in the TCM 116, while having one or several IMC unit(s) 148 connected to the calculation core 102 and/or to the vector calculation core 130 through stream links.

Further details regarding the implementation of the stream links and the stream controller 146 are disclosed in the document US 2018/189424 A1.

The different features and variants previously described for the first, second and third embodiments may apply to the fourth embodiment.

For the various embodiments and variants, the computing circuit 100 can comprise other elements, such that register(s), control unit(s), etc., which are not described here.

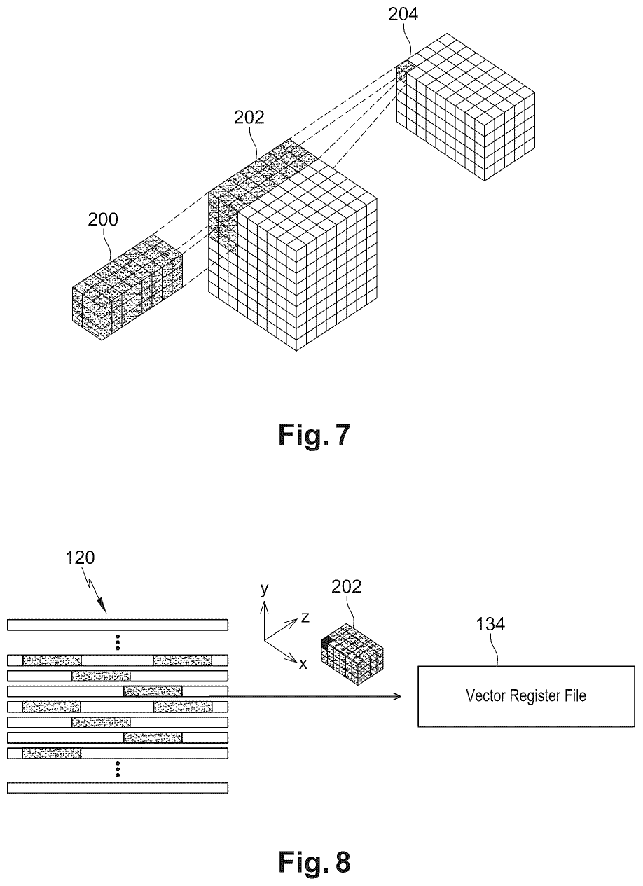

FIG. 7 schematically illustrates an example of calculation, or computation, performed by the computing circuit 100. This calculation corresponds to a convolution between kernel data 200 and tensor data, or feature data, 202. The reference 204 designates the result data obtained with the implementation of this convolution. In this example, kernel data 200, tensor data 202 and result data 204 correspond to vectors.

In all the embodiments and variants of the computing circuit 100, IMC computation starts when both kernel data 200 and tensor data 202 are loaded inside the IMC memory circuit(s) 128. Kernel and tensor data are usually located in an external memory, and it is necessary to consider the time to move data to the IMC memory circuit(s) 128.

To maximize IMC computational throughput, one or several efficient data fetching and storage strategies can be implemented by the computing circuit 100.

In a particular embodiment, a first data fetching and storage strategy is to implement an efficient data organization for optimized IMC loading of tensor data from an external memory to the vector register file 134, or to the register file 112 for the embodiments shown in FIGS. 1, 3, 5 and 6. In a particular embodiment, the vector calculation core 130 comprises an instruction set which includes vector memory read instructions to fetch tensor data, which forms a three-dimension matrix, from the external memory 120 to the vector register file 134 of the vector calculation core 130, such that the tensor data is flatten following an order Z>Y>X, with X, Y and Z corresponding to the three axis of the matrix.

FIG. 8 illustrates an example of data organization implemented with a fetching of tensor data from the external memory 120 and a storage of these data in the vector register file 134. In this example, data coming from the external memory 120 are fetched and stored in the vector register file 134 in a specific order to then streamline both loading into the IMC memory circuit(s) 128 and data reorganization after each convolution window slide step. In a particular embodiment, this optimized data fetching strategy can be implemented using specialized RISC-V vector memory read instructions that allow for irregular data fetching. In the example shown in FIG. 8, the tensor data are flatten following the order of the dimensions Z>Y>X. This approach simplifies data manipulation and promotes efficient data reuse by the computing circuit 100.

In a particular embodiment, a second data fetching and storage strategy to maximize IMC computational throughput is to minimize the number of RISC-V data fetching transactions required for a given convolution by mean of a data manipulation strategy within the vector register file 134, or to the register file 112 for the embodiments shown in FIGS. 1, 3, 5 and 6. In a particular embodiment, the vector calculation core 130 comprises an instruction set which includes data manipulation instructions configured to, during consecutive first and second convolutions of tensor data with kernel data, shift the tensor data stored in the vector register file 134 and used for the first convolution such that part of these tensor data common to the first and second convolutions are kept in the vector register file 134. These data manipulations can also be applied on data stored in the register file 112.

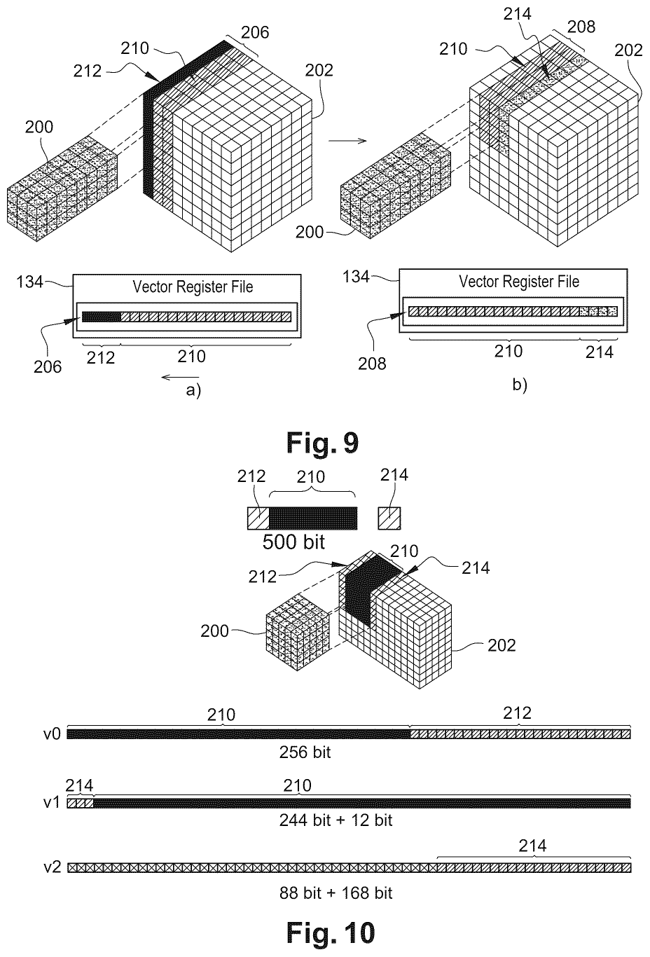

FIG. 9 illustrates an example of data reordering implemented in the vector register file 134 during two consecutive convolutions of the kernel data 200 with the tensor data 202. In this figure, a first convolution is implemented between the kernel data 200 and a first part 206 of the tensor data 202 (situation a) in FIG. 9), and then a second convolution is implemented between the kernel data 200 and a second part 208 of the tensor data 202 (situation b) in FIG. 9). The reference 210 designates the part of the tensor data which is used for both first and second convolutions, the reference 212 designates the part of the tensor data 202 which is used for the first convolution but not for the second convolution, and the reference 214 designates the part the tensor data 202 which is used for the second convolution but not for the first convolution. In order to reduce the amount of data to write in the vector register file 134, specific data manipulation instructions are implemented to shift the tensor data stored in the vector register file 134 such that, at the end of the data manipulation, the part of the tensor data 202 which is used for the first convolution but not used for the second convolution is removed from the vector register file 134, and the part of the tensor data which is used for the second convolution but not used for the first convolution is added in the vector register file 134. The arrow shown below the vector register file 134 of the situation a) of the FIG. 9 represents the direction of the data shifting implemented in the vector register file 134.

Such data reordering enables to optimize the data reuse within the vector register file 134 during consecutive convolutions. This technique enables to limit the amount of external memory fetch instructions, and reduces the IMC loading time and overall convolution execution time.

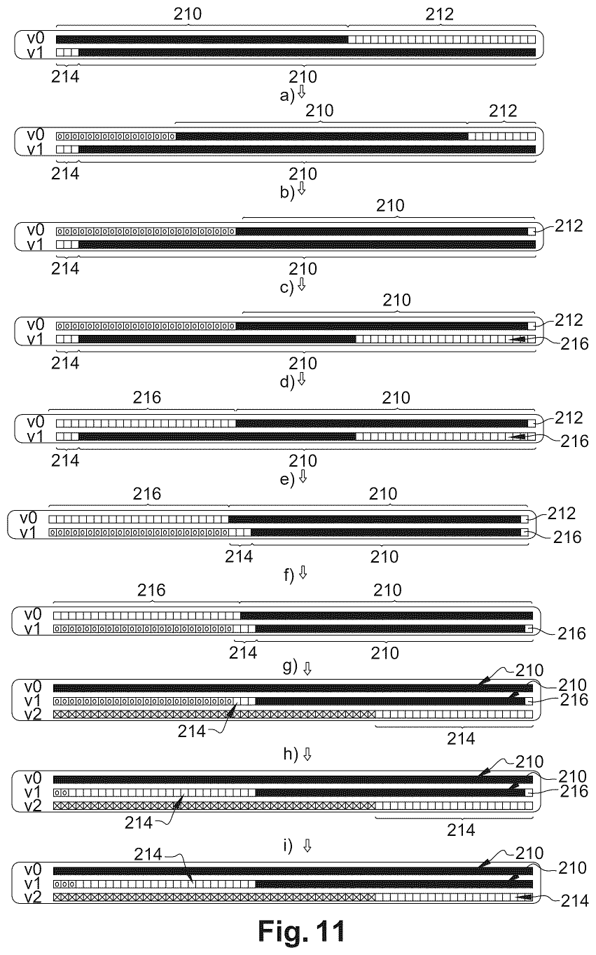

FIGS. 10 and 11 illustrate another example of data reordering implemented during consecutive first and second convolutions of the tensor data 202 with the kernel data 200 to reuse the data already stored in the vector register file 134. FIG. 10 illustrates the first convolution which is implemented between the kernel data 200 and the part 206 of tensor data 202, the second convolution being intended to be implemented between the kernel data 200 and the part 208 of the tensor data 202. The reference 210 designates the part of the tensor data which is used in both first and second convolutions. In FIG. 10, three vectors v0, v1 and v2 of the vector register file 134 in which the parts 206 and 208 of tensor data 202 are stored are shown. In the initial state shown in FIG. 10, each vector v0, v1 and v2 stores 256 bits.

FIG. 11 shown the different operations implemented to shift the data stored in the vectors v0, v1 and v2, between the first and second convolutions.

A first operation a) corresponds to a shift to the right of 64 bits implemented in the vector v0.

A subsequent operation b) corresponds to a shift to the right of 32 bits implemented in the vector v0.

A subsequent operation c) corresponds to a highlight of data to be moved from v1 to v0. In this example, the number of bits to be moved from v1 to v0 corresponds to the number of bits previously shifted in v0 (96 bits in this example). Highlighted data are designated by the reference 216.

In a subsequent operation d), previously highlighted data 216 are copied in v0.

In a subsequent operation e), a shift to the right of 96 bits is implemented in v1.

In a subsequent operation f), a shift to the right of 4 bits is implemented in v0.

In a subsequent operation g), previously highlighting of data 216 is deleted.

In a subsequent operation h), data (96 bits) are copied from v2 to v1.

In a subsequent operation i), a shift to the right of 4 bits is implemented in v1.

In a particular embodiment, a third data fetching and storage strategy to maximize IMC computational throughput is to reduce the IMC loading cycles by optimizing data fetching from the vector register file 134, or to the register file 112 for the embodiments shown in FIGS. 1, 3, 5 and 6, exploiting multiple-row reads for single cycle IMC loading. In a particular embodiment, the vector calculation core 130 is configured to load in parallel, in a single cycle, data stored in several register of the vector register file 132 in a location of the IMC memory circuit(s) 128. Depending on the IMC input size and the length of the vectors, different types of data loads may be required. This strategy can also be applied on data stored in the register file 112. The flexibility of the RISC-V architecture allows for multiple vector register loads, enabling the throughput maximization. More specifically, multiple registers of the vector register file 134 can be fetched in parallel to optimize IMC row loading. With this approach, up to 256 bits vector data can be loaded in an IMC location in a single cycle (considering a vector register file 134 of 32×64 bit). For example, data stored in four vectors of the vector register file 134 can be loaded in parallel, in a single cycle, in the IMC memory circuit(s) 128.

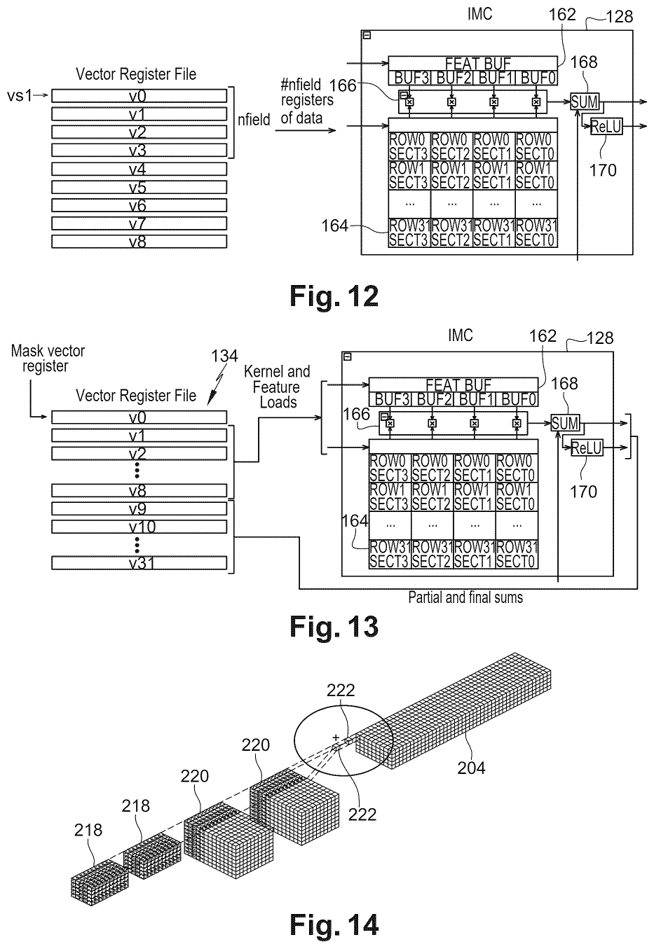

FIG. 12 shows an example of fetching data stored in multiple registers of the vector register file 134 in the IMC memory circuit(s) 128. In this figure, the IMC memory circuit 128 comprises feature, or tensor, buffer 162 configured to store the feature, or tensor, data. The IMC memory circuit 128 also comprises kernel memory 164 configured to store the kernel data. The IMC memory circuit 128 also comprises calculation elements 166 configured to calculate the operations which are required for the convolutions between the feature data and the kernel data, a summing device 168 to add the partial sums obtained at the output of the calculation elements, and an element 170 to output the final sum obtained by the addition of the partial sums.

In a particular embodiment, a fourth data fetching and storage strategy to maximize IMC computational throughput is to fully exploit the register file memory space in the context of batched convolutions thanks to an efficient use of the register file for partial sum storage during a write back operation. In a particular embodiment, the vector calculation core 130 comprises at least one vector register file 134 configured to store several partial sums resulting of convolutions implemented by the vector calculation core 130. This strategy can also be applied for the register file 112.

FIG. 13 schematically illustrates an example of such write back strategy, which enables to store several partial sums in the vector register file 132 before writing them to the external memory 120. This approach allows for the direct reuse of partial sums from the vector register file 134, provided the batch size permits it, eliminating the need to re-fetch them from the external memory 120.

Local storage of the partial sums plays a role in accelerating the execution of convolutions that require batching. Indeed, by storing the partial sums locally, the computing circuit 100 significantly reduces the need to access the external memory 120 for retrieving partial sums between consecutive batch convolutions. This strategy not only minimizes memory latency but also improves overall efficiency, as the frequent external memory access can introduce delays and increase power consumption.

To calculate the partial sums, kernel data 200 can be separated into at least two partial kernel data 218. The calculation results obtained when these partial kernel data 218 correspond to the partial sums which are then added one to the other to obtain the final sum.

FIG. 14 schematically shows an example of operations implemented on tensor data with partial kernel data 218 by the computing circuit 100 according to a particular embodiment. In this figure, the partial kernel data are designated by the reference 218. In this example, tensor data are also separated into several blocks referenced 220. The reference 222 designate the partial sums which are obtained, this partial sums being added to obtain the result data 204.

One or several of the different above described fetching and organization strategies can be implemented by the computing circuit, and for example combined one to the other to improve the performances of the computing circuit 100.

In the different embodiments and variants of the computing circuit 100, to manage data movement and control signals from/to the IMC memory circuit(s) 128, new custom instructions can be introduced.

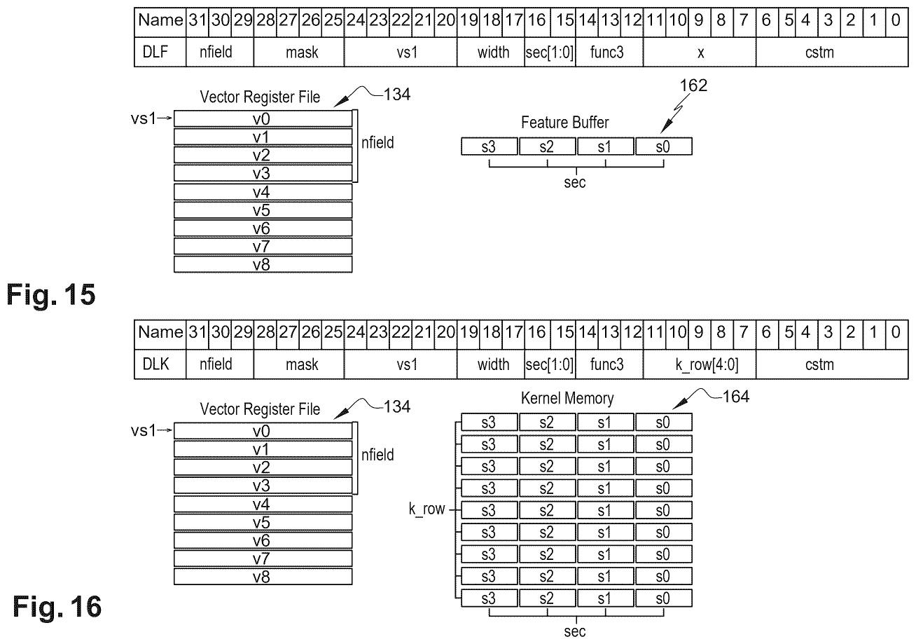

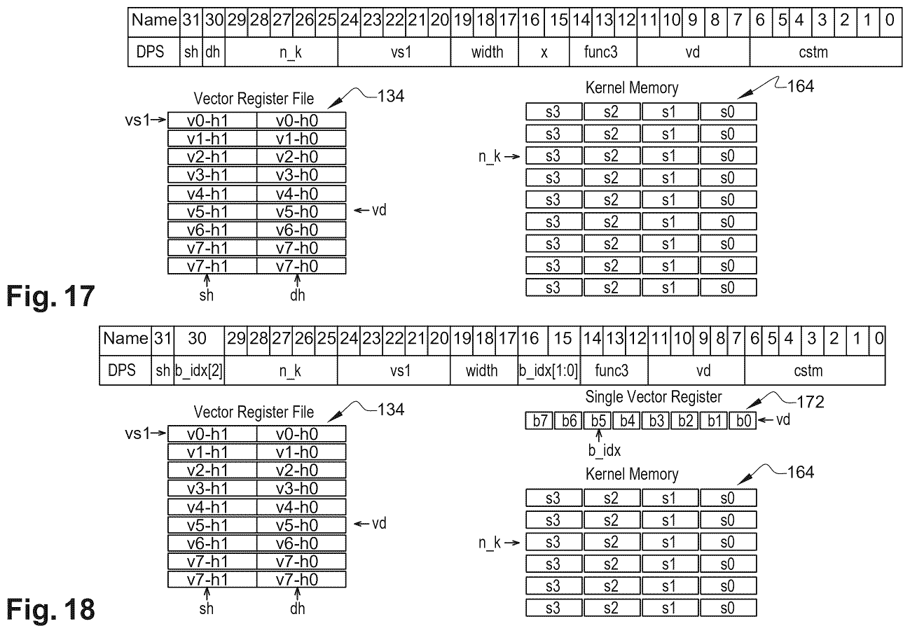

For example, among these new custom instructions, new load instructions correspond to:
DLF: Loads feature data 202 into the feature buffer 162 (see FIG. 15 showing an example of fields of this instruction, and the relation of these fields with the structure of the vector register file 134 and of the feature buffer 162);
DLK: Loads kernel data 200 into the kernel memory 164 (see FIG. 16 showing an example of fields of this instruction, and the relation of these fields with the structure of the vector register file 134 and of the kernel memory 164).

In addition, among these new custom instructions, new computation and store instructions can correspond to:
DPS: Initiates computation and stores the partial sum (see FIG. 17 showing an example of fields of this instruction, and the relation of these fields with the structure of the vector register file 134 and of the kernel memory 164);
DSS: Initiates computation and stores the final sum (see FIG. 18 showing an example of fields of this instruction, and the relation of these fields with the structure of the vector register file 134, the kernel memory 164 and a single vector register 172).

The performances of a computing circuit 100 derived from the previously described computing circuit 100 shown in FIG. 2 are calculated and compared to those of a computing circuit 10 comprising all the elements of this computing circuit 100 except the IMC memory circuit 128.

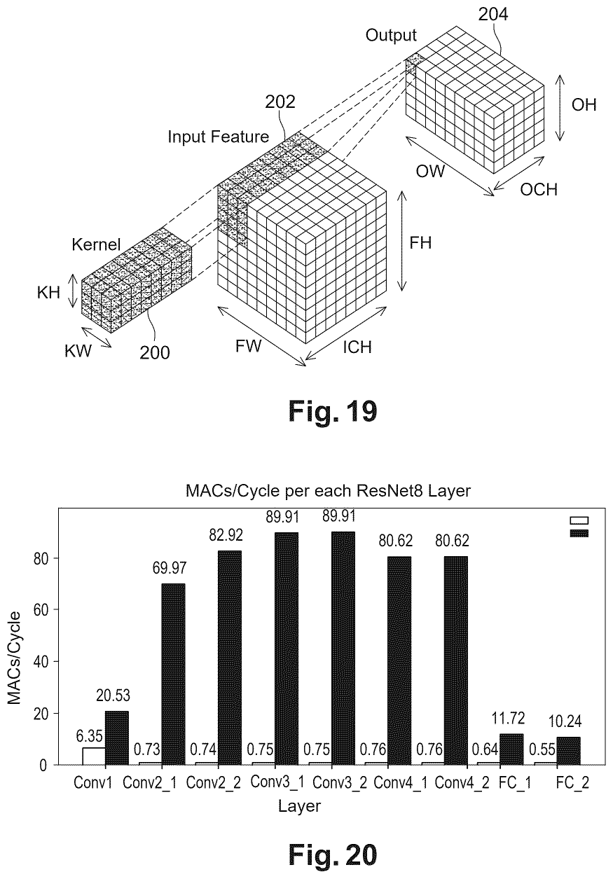

For the calculation of these performances, convolutions between kernel data 200 and tensor data 202 are carried out. The dimension of these data as shown in FIG. 19 are considered for the calculation of the performances.

The performance metrics which are calculated are:

Speedup=ClockCyclesCircuit10/ClockCyclesCircuit100;

wherein ClockCyclesCircuit10 corresponds to number of clock cycles used by the computing circuit 10, and ClockCyclesCircuit100 corresponds to number of clock cycles used by the computing circuit 100.

The convolution workload metrics which are calculated are:

MACₜₒₜ=KH*KW*ICH*OH*OW*OCH

MACₚₐₜₕ=KH*KW*ICH*OCH

MAC_{SingleKernelPatch}=KH*KW*ICH

wherein KH and KW are dimensions of the kernel data 200, ICH is a dimension of the feature data 202, and OH, OW and OCH are dimensions of the result data 204.

The performance workload metric which is calculated is:

MACs/Cycle=MACₜₒₜ/ClockCycles

FIG. 20 shows the MACs/Cycle performance obtained in each layer of ResNet8 neural network calculated with the computing circuit 10 (results shown in grey) and with the computing circuit 100 (results shown in black). These performances show that, thanks to the addition of the IMC memory circuit 128, the total network speedup is equal to 108, and the average layer speedup is equal to 77.

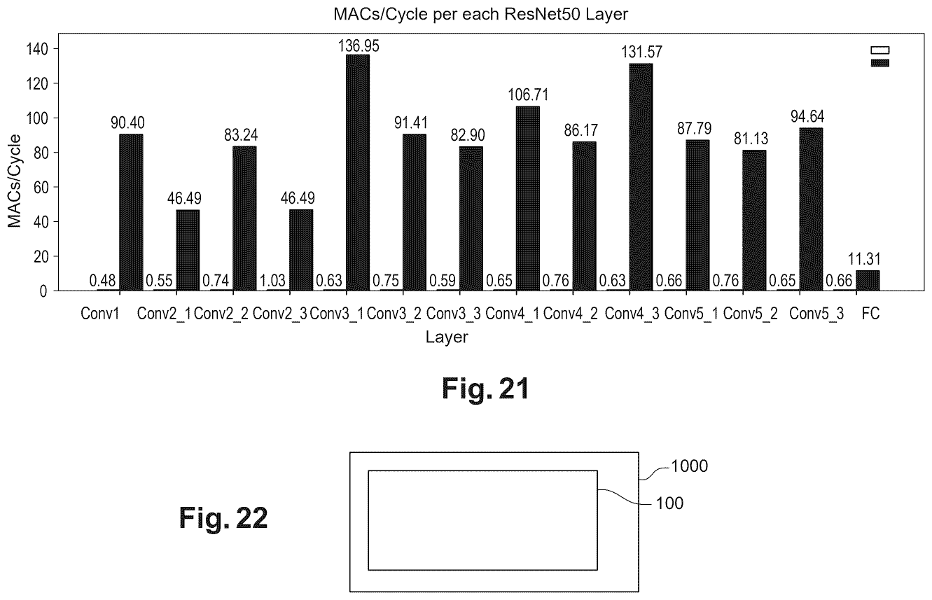

FIG. 21 shows the MACs/Cycle performance obtained in each layer of ResNet50 neural network calculated with the computing circuit 10 (results shown in grey) and with the computing circuit 100 (results shown in black). These performances show that, thanks to the addition of the IMC memory circuit 128, the total network speedup is equal to 123, and the average layer speedup is equal to 128.

It is thus proposed a computing circuit 100, or system, comprising a at least one calculation core, at least one memory circuit configured to implement IMC, and wherein the calculation core comprises decoding circuitry to decode a plurality of instructions in an execution pipeline.

To support IMC integration in the proposed embodiments, an expansion of the RISC-V Instruction Set Architecture (ISA) of the computing circuit 100 is proposed. This integration may leverage custom ISA extensions designed for IMC, optimizing its functionality for example to accelerate deep learning tasks while minimizing the overhead of data transfers.

The proposed computing circuit 100 represents a strategic choice to maximize energy efficiency, reduce processing time, and enable real-time execution of AI workloads on embedded systems.

To efficiently exploit IMC and effectively accelerate the target workload, the computing circuit 100 may extend the RISC-V ISA to support IMC operation, redesign the vector architecture and define efficient data mapping strategies.

In the computing circuit 100, IMC offers a paradigm shift by integrating computational capabilities directly into memory arrays. Unlike conventional architectures that separate computation and data storage, IMC executes operations such as multiplications and additions within the memory itself. This approach minimizes data movement, which lead to a significant reduction of latency and power consumption, by streamlining the processing of matrix-intensive tasks like those found for example in convolutional neural networks, CNNs.

With the RISC-V architecture of the computing circuit 100, thanks to its extensible ISA, it allows for seamless implementation of application-specific extensions, enabling hardware designs tailored to specific computational workloads.

The computing circuit 100 enables to leverage the modular and opensource RISC-V microprocessor architecture, for the integration of IMC accelerator.

RISC-V's ISA provides an ideal framework for parallel data processing, significantly enhancing the performance of IMC by optimizing the execution of vectorized operations in deep learning tasks.

The proposed computing circuit 100 enables:
enhanced data handling: efficient mapping of input features and kernels data in memory to reduce data transfer overheads and optimize RF utilization;
custom instruction set: introduction of custom instructions tailored for IMC operations to simplify control logic and improve execution throughput;
high bandwidth processing: utilization of 1024-bit IMC buffers and vectorized operations to leverage parallelism in convolution tasks, reducing memory latency and maximizing memory bandwidths.

The computing circuit 100 enables integration of IMC into a RISC-V processor to enhance computational efficiency, particularly for deep learning applications on edge computing devices. The proposed solution addresses the challenge of balancing power consumption, latency, and area constraints while accelerating convolutional operations critical for neural networks.

In some embodiments, the integration of IMC as functional unit inside calculation core accelerates computations using specialized instructions, while the integration of IMC inside TCM model minimizes memory access bottlenecks and enables broader compatibility with other cores due to fewer architectural customizations. In some embodiment, the stream-based approach offers another set of advantages with respect to the other integration strategies: by leveraging data streams, RISC-V and IMC can operate in a fully decoupled approach. IMC processes data only when data are available at its input. The RISC-V automatically fetches results back when data are ready.

Each of these solutions enhance performance and energy efficiency, offering different trade-offs in terms of PPA (Power, Performance and Area), integration strategy effort, and overall computational throughput. All of them represent scalable and flexible options for edge-based neural network inference for example.

Moreover, the computing circuit 100 enables a set of efficient data mapping strategies for optimized data loading and storing to and from the IMC, minimizing the number of external memory accessing by exploiting the RISC-V register file or vector register file.

FIG. 22 shows an apparatus 1000 which includes the computing circuit 100. For example, the apparatus 1000 corresponds to a microprocessor (CPU or MPU) or a microcontroller (MCU) or a system-on-chip (SoC).

The computing circuit 100 may be used for example for neural network applications, e.g. for audio, video, image or signal processing, artificial neural networks (ANN), convolutional neural network (CNN), deep neural network (DNN), and may form a CNN accelerator. The computing circuit 100 may be used to implement Matrix-Vector Multiplication (MVM).

The computing circuit 100 may be incorporated in an AI accelerator, or a NPU (Neural Processing Unit).

The computing circuit 100 may be used in an edge-computing device, and enables to have an energy-efficient embedded system.

It is also disclosed a non-transitory computer-readable medium comprising instructions stored thereon, that if executed by one or more computing circuits, cause the one or more computing circuits to perform calculations wherein an execution stage is configured to use the one or several memory circuits implemented as IMC. All the previously described features of computing circuit 100 can apply to this non-transitory computer-readable medium.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A computing circuit comprising:
at least one calculation core based on a reduced instruction set computer, RISC-V, pipelined architecture;
one or several memory circuits configured to implement in-memory computing, IMC;
and wherein the at least one calculation core comprises an execution stage configured to use the one or several memory circuits to implement IMC.

2. The computing circuit of claim 1, wherein at least one of the one or several memory circuits is embedded in the at least one calculation core and configured to be used as an IMC functional unit of the execution stage of the at least one calculation core.

3. The computing circuit of claim 1, further comprising an interconnect linking the at least one calculation core to at least one tightly-coupled memory and to a bus to which an external memory is coupled.

4. The computing circuit of claim 3, wherein the at least one tightly-coupled memory corresponds to at least one of the one or several memory circuits.

5. The computing circuit of claim 1, wherein the execution stage of the at least one calculation core comprises at least one stream controller and at least one of the one or several memory circuits is connected to the at least one stream controller through input and output stream links.

6. The computing circuit of claim 1, further comprising a vector calculation core configured to implement computations on vector data and comprising a RISC-V pipelined architecture.

7. The computing circuit of claim 6, wherein at least one of the one or several memory circuits is embedded in the vector calculation core and configured to be used as an IMC functional unit of an execution stage of the vector calculation core.

8. The computing circuit of claim 3, further comprising a vector calculation core configured to implement computations on vector data and comprising a RISC-V pipelined architecture, and wherein the interconnect also links the vector calculation core to the at least one tightly-coupled memory and to the bus to which the external memory is coupled.

9. The computing circuit of claim 6, wherein the vector calculation core comprises an instruction set which includes vector memory read instructions to fetch tensor data which forms a three-dimension matrix, from an external memory to at least one vector register file of the vector calculation core, such that the tensor data is flatten following an order Z>Y>X, with X, Y and Z corresponding to three axes of the three-dimension matrix.

10. The computing circuit of claim 1, wherein the at least one calculation core comprises an instruction set which includes data manipulation instructions configured to, during consecutive first convolution and second convolution of tensor data with kernel data, shift the tensor data stored in at least one register file of the at least one calculation core and used for the first convolution such that part of the tensor data common to the first convolution and the second convolution are kept in the at least one register file.

11. The computing circuit of claim 1, wherein the at least one calculation core is configured to load in parallel, in a single cycle, data stored in several registers of at least one register file of the at least one calculation core in a location of at least one of the one or several memory circuits.

12. The computing circuit of claim 1, wherein the at least one calculation core comprises at least one register file configured to store several partial sums resulting of convolutions implemented by the at least one calculation core.

13. The computing circuit of claim 1, wherein the one or several memory circuits are digital and/or analog IMC circuits.

14. The computing circuit of claim 1, wherein the at least one calculation core comprises at least one register file and at least four stages including an instruction fetch stage, an instruction decode stage, the execution stage, and a write back stage.

15. An apparatus corresponding to a microprocessor comprising at least one computing circuit of claim 1.

16. An apparatus corresponding to a microcontroller comprising at least one computing circuit of claim 1.

17. An apparatus corresponding to a system-on-chip comprising at least one computing circuit of claim 1.
